(19) United States
(12) Patent Application Publication
(10) Pub. No.: US 2026/0336872 A1
(43) Pub. Date: Oct. 29, 2026

(54) Mosaic Container

(71) Applicants: Xinyi Lin, Cumming, GA (US); Xinyu Liang, Shenzhen (CN)

(72) Inventors: Xinyi Lin, Cumming, GA (US); Xinyu Liang, Shenzhen (CN)

(21) Appl. No.: 19/266,343

(22) Filed: Jul. 11, 2025

(30) Foreign Application Priority Data
Apr. 29, 2025 (CN) CN202520846034.6

(51) Int. Cl. B65D 25/20; B65D 1/40

(52) U.S. Cl. CPC B65D 25/20; B65D 1/40

(57) ABSTRACT

A mosaic container includes a plastic container body with pre-set mosaic pits and detachable plastic particles. Each pit has a slot with snap-fit protrusions and a through-hole forming a limit step. The particles feature frosted inner/smooth outer surfaces, easily snapping into slots without glue, allowing repeated reassembly, friendly for children/beginners. Prearranged pits ensure neat aesthetics when particles are embedded, with no gaps between fully inserted particles to reduce dust accumulation and ease cleaning. This patent solves traditional mosaic container issues of messy glue and putty, uneven pasting, and hard-to-clean gaps.

### FIELD OF THE INVENTION

The present invention relates to the technical field of creative crafts, and in particular, to a mosaic container.

### BACKGROUND ART

Mosaic containers such as cups, pen holders, and vases are creative crafts that apply mosaic art to container production. Traditional mosaic containers usually use glue to paste mosaic particles on the surface of the container and then fill the gaps between the mosaic particles with putty. This making method has the following problems:
1. The making process is cumbersome, requiring the use of glue and putty, which is complex and time-consuming to operate;
2. It is easy for the mosaic particles to be unevenly pasted, affecting the appearance;
3. For children or beginners, DIY is difficult and prone to failure;
4. The gaps between the mosaic particles are easy to collect dust and difficult to clean.

### BRIEF SUMMARY OF THE INVENTION:

In view of the above, the purpose of the present invention is to provide a mosaic container to solve the above problems.

The present application provides a mosaic container, including a container body and a plurality of mosaic particles. The peripheral wall of the container body is provided with a plurality of mosaic pits at intervals. Each mosaic pit includes a slot and a through-hole arranged at the bottom of the slot, so that the bottom of the slot has a limit step. The peripheral wall of the slot is provided with a plurality of snap-fit portions. The mosaic particles are adapted to the slot and are detachably snapped into the slot through the cooperation of their outer peripheral walls with the snap-fit portions.

Further, the snap-fit portion is a semi-cylindrical protrusion.

Further, a guide surface is arranged between the inner surface and the outer peripheral surface of the mosaic particle.

Further, the guide surface is an arc surface.

Further, the inner surface of the mosaic particle is a frosted surface, and the outer surface is a smooth surface.

Further, the container body is made of Polyethylene Terephthalate (PET) or Polypropylene (PP) material; the mosaic particles are made of Polystyrene (PS) or PET material.

Further, the height of the mosaic particle is adapted to the depth of the slot.

Further, the slot is square, the through-hole is a circular through-hole inscribed in the slot; the snap-fit portions are respectively arranged on the four peripheral walls of the slot.

Further, the shape of the slot is diamond, circle, petal, spindle, fish scale, heart, pentagram or polygon.

Further, there are mosaic particles with a variety of different single colors and/or mosaic particles with a variety of different colors on them.

By adopting the above technical scheme, the present invention can achieve the following technical effects:

By presetting mosaic pits on the peripheral wall of the container body and arranging snap-fit portions on the slots of the mosaic pits, the detachable snap-fit of the mosaic particles is realized without the need for glue bonding, which can be repeatedly disassembled and reassembled, and is more friendly to children or beginners.

The preset mosaic pits can make the whole neater and more beautiful after many mosaic particles are embedded.

The mosaic particles are completely embedded in the slots, so that there are no gaps between the mosaic particles, which is not easy to collect dust and easy to clean.

### BRIEF DESCRIPTION OF THE DRAWINGS

In order to more clearly illustrate the technical solutions of the embodiments of the present invention, the following briefly introduces the drawings required for the embodiments. It should be understood that the following drawings only show some embodiments of the present invention and should not be regarded as limiting the scope. Those of ordinary skill in the art can also obtain other related drawings based on these drawings without creative efforts.

FIG. 1 is a schematic structural diagram of a square container body of a mosaic container according to an embodiment of the present invention;

FIG. 2 is a schematic structural diagram of a cylindrical container body of a mosaic container according to an embodiment of the present invention;

FIG. 3 is a schematic front structural diagram of FIG. 1;

FIG. 4 is a schematic cross-sectional structural diagram along A-A in FIG. 3;

FIG. 5 is an enlarged schematic structural diagram of A in FIG. 4;

FIG. 6 is a schematic front structural diagram of a single mosaic pit of a mosaic container according to an embodiment of the present invention;

FIG. 7 is a schematic front structural diagram and a schematic side structural diagram of a mosaic particle of a mosaic container according to an embodiment of the present invention;

FIG. 8 is a schematic side structural diagram of a mosaic particle for a cylindrical container body of a mosaic container according to an embodiment of the present invention;

FIG. 9 is a schematic structural diagram of other mosaic particle shapes of a mosaic container according to an embodiment of the present invention;

Icons: container body 1, mosaic pit 2, slot 3, through-hole 4, snap-fit portion 5, limit step 6, inner surface 7, outer surface 8, guide surface 9, mosaic particle 10.

### DETAILED DESCRIPTION OF THE EMBODIMENTS:

In order to make the purpose, technical solutions and advantages of the embodiments of the present invention clearer, the technical solutions in the embodiments of the present invention will be clearly and completely described below in conjunction with the drawings in the embodiments of the present invention. Obviously, the described embodiments are part of the embodiments of the present invention, rather than all embodiments. Based on the embodiments of the present invention, all other embodiments obtained by those of ordinary skill in the art without creative efforts belong to the protection scope of the present invention. Therefore, the following detailed description of the embodiments of the present invention provided in the drawings is not intended to limit the scope of the claimed present invention, but only represents selected embodiments of the present invention. Based on the embodiments of the present invention, all other embodiments obtained by those of ordinary skill in the art without creative efforts belong to the protection scope of the present invention.

### Embodiment

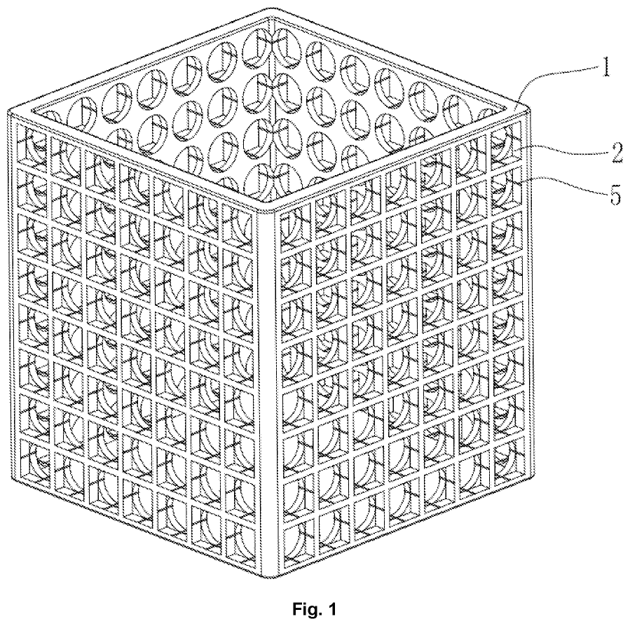

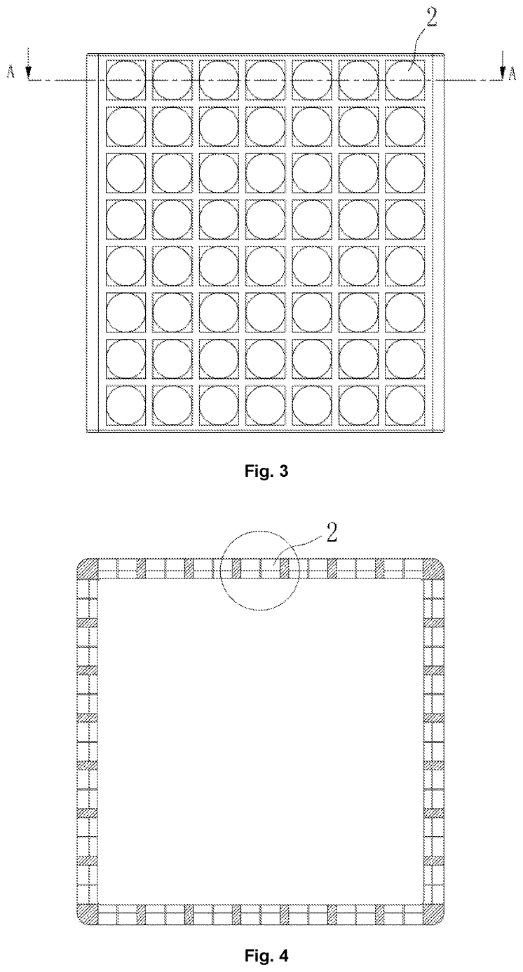

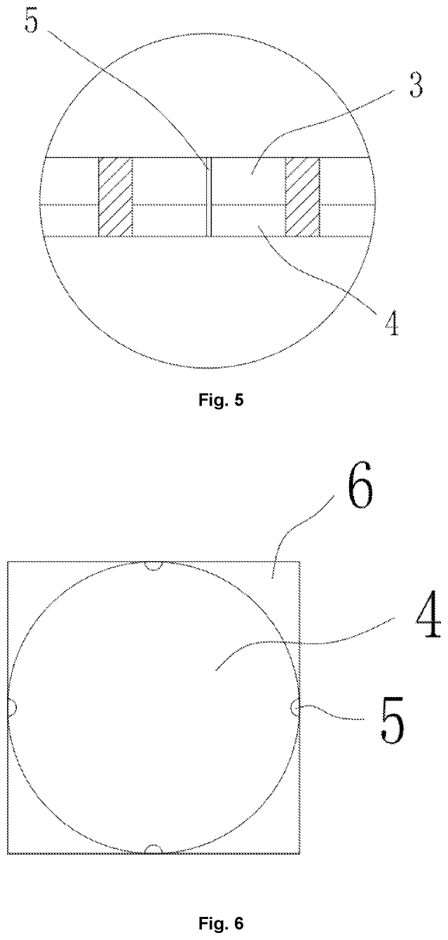

As shown in FIGS. 1 to 8, this embodiment provides a mosaic container, including a container body 1 and a plurality of mosaic particles 10. The peripheral wall of the container body 1 is provided with a plurality of mosaic pits 2 at intervals. Each mosaic pit 2 includes a slot 3 and a through-hole 4 arranged at the bottom of the slot 3, so that the bottom of the slot 3 has a limit step 6. The peripheral wall of the slot 3 is provided with a plurality of snap-fit portions 5. The mosaic particles 10 are adapted to the slot 3 and are detachably snapped into the slot 3 through the cooperation of their outer peripheral walls with the snap-fit portions 5.

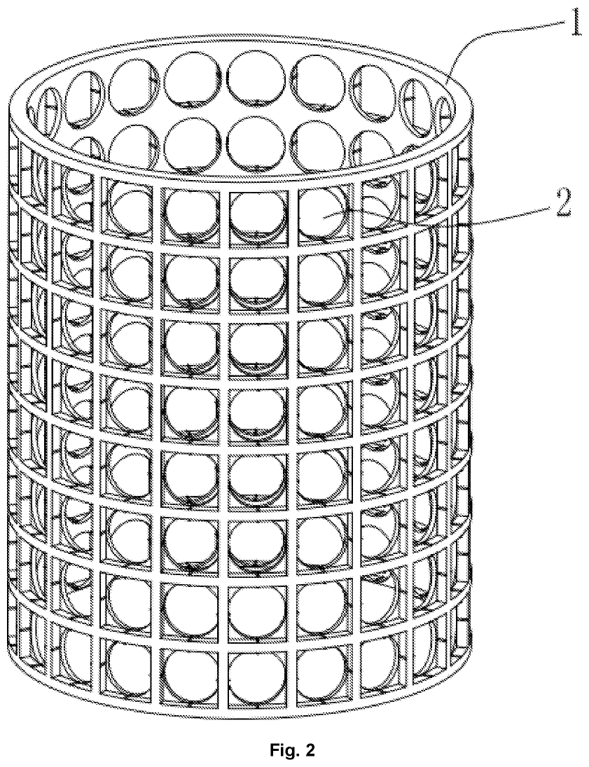

Specifically, as shown in FIGS. 1 and 2, take a square container body 1 and a cylindrical container body 1 as examples. The peripheral wall of the container body 1 is provided with a plurality of mosaic pits 2 at intervals. As shown in FIGS. 1 and 6, each mosaic pit 2 includes a square slot 3 and a circular through-hole 4 inscribed in the slot 3 at the bottom of the slot 3. The snap-fit portions 5 are semi-cylindrical protrusions protruding toward the axis of the slot 3 and are respectively arranged on the four peripheral walls of the slot 3. Four limit steps 6 are formed at the four corners of the bottom of the slot 3. The setting of the limit steps 6 ensures that the mosaic particles 10 will not fall into the inner cavity of the container body 1 after being completely embedded in the slot 3. The setting of the through-hole 4 not only facilitates the disassembly of the mosaic particles 10 embedded in the slot 3 but also enables the container body 1 to have good light transmittance, so that when the container body 1 is used as a candlestick for an LED candle, it has a better light transmission effect.

This way realizes the detachable snap-fit of the mosaic particles 10 without the need for glue bonding, which can be repeatedly disassembled and reassembled, and is more friendly to children or beginners. At the same time, the preset mosaic pits 2 can make the whole neater and more beautiful after many mosaic particles 10 are embedded.

In this embodiment, taking a slot 3 with a side length of 1 cm as an example, through many tests, while ensuring the overall aesthetics, the interval between two slots 3 is set to 1.83 mm to ensure its firmness. Of course, according to different sizes and shapes of the slots 3, the interval between the slots 3 needs to be adjusted accordingly.

In this embodiment, as shown in FIG. 7, the shape of the mosaic particle 10 is square adapted to the slot 3. It includes an inner surface 7 and an outer surface 8. The inner surface 7 is a surface in contact with the limit step 6, and a guide surface 9 is arranged between the inner surface 7 and the peripheral wall. Preferably, the guide surface 9 is an arc surface. In this way, the area of the end surface of the inner surface 7 is smaller than the area of the slot 3, and with the transition of the arc surfaces around, the operator can quickly insert the mosaic particle 10 into the mosaic pit 2.

Further, in order for the user to quickly distinguish the inner surface 7 with the arc surface and the outer surface 8 without the arc of the mosaic particle 10 and avoid inserting the outer surface 8 into the mosaic pit 2, which may cause unnecessary installation difficulties, the inner surface 7 of the mosaic particle 10 is set as a frosted surface, and the outer surface 8 is set as a smooth surface. The smooth surface and the frosted surface can be directly formed by a mold.

In this embodiment, the height of the mosaic particle 10 is adapted to the depth of the slot 3. So that after the mosaic particle 10 is embedded in the mosaic pit 2, the outer surface 8 of the mosaic particle 10 is flush with the outer wall surface of the container body 1, so that there are no gaps between the mosaic particles 10, which is not easy to collect dust and easy to clean.

Preferably, the container body 1 is made of PET or PP material, so that the container body 1 can withstand the pressure of pressing without deformation and cracking. The mosaic particles 10 are made of PS or PET material to meet the special needs of their creativity. It should be noted that the above materials are only preferred solutions and are not limited to the above materials.

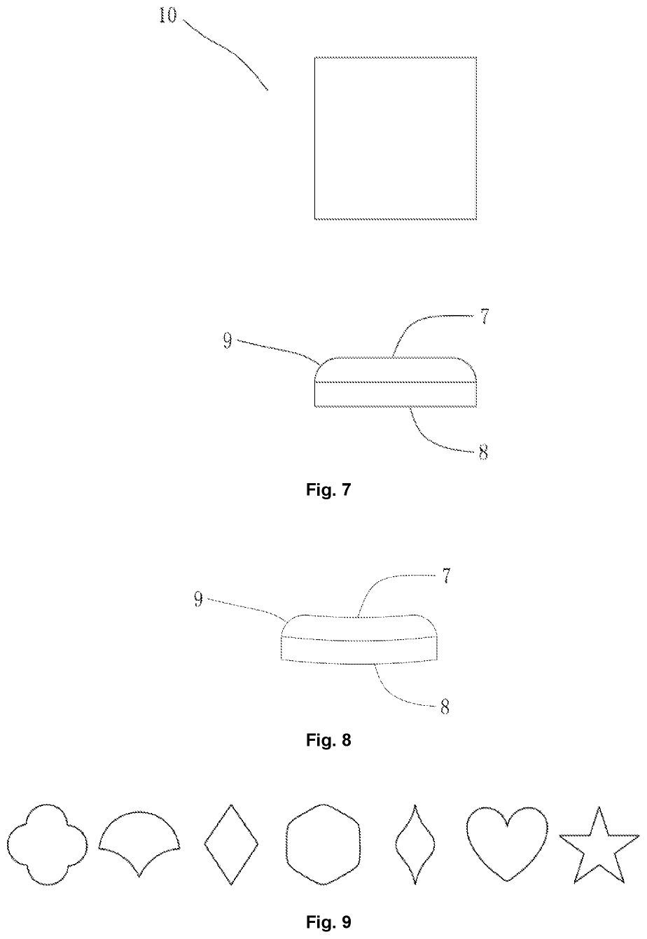

It should be noted that the difference between the mosaic pits 2 of the cylindrical container body 1 and the square container body 1 is that the outer peripheral surface of the cylindrical container body 1 and the end surface of the limit step 6 have a certain curvature. Therefore, as shown in FIG. 8, the inner surface 7 and the outer surface 8 of the mosaic particle 10 also have a curvature adapted to it.

The container body 1 can also be in other three-dimensional shapes. As shown in FIG. 9, the shape of the slot 3 can also be other shapes such as diamond, circle, petal, spindle, fish scale, heart, pentagram or polygon. The shape of the mosaic particle 10 is adapted to the slot 3. Among the many mosaic particles 10, there can be mosaic particles 10 with a variety of different single colors, or some single mosaic particles 10 can have a variety of different colors. So that users can combine them to spell out various patterns with different effects, increasing the fun and improving the user experience.

The above are only preferred embodiments of the present invention, and the protection scope of the present invention is not limited to the above embodiments. All technical solutions under the idea of the present invention belong to the protection scope of the present invention.

1. A mosaic container, comprising a container body and a plurality of mosaic particles. The peripheral wall of the container body, is provided with a plurality of mosaic pits at intervals. Each mosaic pit comprises a slot and a through-hole arranged at the bottom of the slot, so that the bottom of the slot has a limit step. The peripheral wall of the slot is provided with a plurality of snap-fit portions. The mosaic particles are adapted to the slot and are detachably snapped into the slot through the cooperation of their outer peripheral walls with the snap-fit portions.

2. The mosaic container according to claim 1, wherein the snap-fit portion is a semi-cylindrical protrusion.

3. The mosaic container according to claim 2, wherein a guide surface is arranged between the inner surface and the outer peripheral surface of the mosaic particle.

4. The mosaic container according to claim 3, wherein the guide surface is an arc surface.

5. The mosaic container according to claim 3, wherein the inner surface of the mosaic particle is a frosted surface, and the outer surface is a smooth surface.

6. The mosaic container according to claim 5, wherein the container body is made of Polyethylene Terephthalate (PET) or Polypropylene (PP) material; the mosaic particles are made of Polystyrene (PS) or PET material.

7. The mosaic container according to claim 1, wherein the height of the mosaic particle is adapted to the depth of the slot.

8. The mosaic container according to claim 1, wherein the slot is square, the through-hole is a circular through-hole inscribed in the slot; the snap-fit portions are respectively arranged on the four peripheral walls of the slot.

9. The mosaic container according to claim 1, wherein the shape of the slot is diamond, circle, petal, spindle, fish scale, heart, pentagram or polygon.

10. The mosaic container according to claim 1, wherein there are mosaic particles with a variety of different single colors and/or mosaic particles with a variety of different colors on them.
